(19) United States
(12) Patent Application Publication
(10) Pub. No.: US 2026/0310559 A1
(43) Pub. Date: Oct. 8, 2026

(54) Restoring from Multiple Sites

(71) Applicant: Dell Products L.P., Round Rock, TX (US)

(72) Inventors: Kaushik Gupta, Pune (IN); Shiv S. Kumar, Pune (IN)

(21) Appl. No.: 19/170,857

(22) Filed: Apr. 4, 2025

(51) Int. Cl. G06F 11/14

(52) U.S. Cl. CPC G06F 11/1469; G06F 11/1448; G06F 11/1464

(57) ABSTRACT

A system can monitor, by an orchestrator, respective computer locations where data representative of a data source is stored. The system can modify, by the orchestrator, a pull policy for a data mover based on the pull policy identifying the data source, and wherein the modifying comprises storing respective indications of the respective computer locations where the data representative of the data source is stored in the pull policy. The system can, based on determining to engage the data mover in a data moving job regarding the data source, access the pull policy by the data mover, to produce identified respective computer locations. The system can select at least one computer location of the identified computer locations, to produce at least one selected computer location. The system can perform the data moving job using the at least one selected computer location.

### BACKGROUND

Computer data can be backed up, and data on a computer can be restored from a backup.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can monitor, by an orchestrator of the system, respective computer locations where data representative of a data source is stored. The system can modify, by the orchestrator, a pull policy for a data mover based on the pull policy identifying the data source, and wherein the modifying comprises storing respective indications of the respective computer locations where the data representative of the data source is stored in the pull policy. The system can, based on determining to engage the data mover in a data moving job regarding the data source, access the pull policy by the data mover, to produce identified respective computer locations where the data representative of the data source is stored. The system can select at least one computer location of the identified computer locations where the data representative of the data source is stored, to produce at least one selected computer location. The system can perform the data moving job using the at least one selected computer location.

An example method can comprise modifying, by an orchestrator component of a system comprising at least one processor, a pull policy for a data mover component based on the pull policy identifying a data source, wherein the modifying comprises storing respective indications of respective computer locations where data representative of the data source is stored in the pull policy, and wherein the orchestrator component is configured to monitor where the data representative of the data source is stored. The method can further comprise, based on determining to engage the data mover component in a data moving job regarding the data source, accessing the pull policy by the data mover component, to produce identified respective computer locations where the data representative of the data source is stored. The method can further comprise selecting, by the system, at least one computer location of the identified computer locations where the data representative of the data source is stored, to produce at least one selected computer location. The method can further comprise performing, by the data mover component, the data moving job using the at least one selected computer location.

An example non-transitory computer-readable medium can comprise instructions that, in response to execution, cause a system comprising a processor to perform operations. These operations can comprise modifying, by an orchestrator, a pull policy for a data mover based on the pull policy identifying a data source, wherein the modifying comprises storing respective indications of respective computer locations where data representative of the data source is stored in the pull policy, and wherein the orchestrator is configured to monitor where the data representative of the data source is stored. These operations can further comprise, based on determining to engage the data mover in a data moving job regarding the data source, accessing the pull policy by the data mover, to produce identified respective computer locations where the data representative of the data source is stored. These operations can further comprise performing the data moving job using at least one selected computer location, wherein the at least one selected computer location is based on the identified computer locations where the data representative of the data source is stored.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate restoring from multiple sites, in accordance with an embodiment of this disclosure;

FIG. 2 illustrates another example system architecture that can facilitate restoring from multiple sites, in accordance with an embodiment of this disclosure;

FIG. 3 illustrates an example process flow that can facilitate restoring from multiple sites, in accordance with an embodiment of this disclosure;

FIG. 4 illustrates another example process flow that can facilitate restoring from multiple sites, in accordance with an embodiment of this disclosure;

FIG. 5 illustrates another example process flow that can facilitate restoring from multiple sites, in accordance with an embodiment of this disclosure;

FIG. 6 illustrates another example process flow that can facilitate restoring from multiple sites, in accordance with an embodiment of this disclosure;

FIG. 7 illustrates another example process flow that can facilitate restoring from multiple sites, in accordance with an embodiment of this disclosure;

FIG. 8 illustrates another example process flow that can facilitate restoring from multiple sites, in accordance with an embodiment of this disclosure;

FIG. 9 illustrates another example process flow that can facilitate restoring from multiple sites, in accordance with an embodiment of this disclosure;

FIG. 10 illustrates another example process flow that can facilitate restoring from multiple sites, in accordance with an embodiment of this disclosure; and

FIG. 11 illustrates an example block diagram of a computer operable to execute an embodiment of this disclosure.

### DETAILED DESCRIPTION

### Overview

In a component or service within a computer storage system that manages data movement operations, there can be policies that decide when to create dataset and when to copy datasets from a source to a target. Even if a scenario manifests where the same dataset is available at more than one storage system (e.g., cluster or cloud), it can be that prior approaches consider only a single storage system as the source.

There can be problems with these prior approaches:
If the one source is not reachable, then the job can go to a paused state.
If the one source is experiencing a high load, the overall job can take longer to complete.
It can be that there is no way to utilize two storage systems for faster recovery or restore of files (or for that matter setting up a new datacenter).

The present techniques can be implemented to facilitate configuring a data movement component or service to function with more than one source accounts. Thus, the policy can have the ability to take more than one source account. Accordingly, some tasks can fetch a file from one specified source (e.g., “src-1”), while other tasks can fetch a file from another source (e.g., “src-2”).

In one example scenario, consider a pull policy-that is, a job is running on the target and pulling the data from the source. If the connection to the source is lost, the restore (or copy) job can transition to a paused state.

If there is more than one source, the failed tasks can be retried automatically with the other source and consecutive tasks can be created with the source that is reachable. That is, if src-1 is not reachable, it can be that the job will not go to a paused state. Rather, tasks will work with src-2 (that is reachable).

In another example scenario, there is infrastructure to generate the statistics that show the time taken to copy X bytes. The source that has a higher latency can be identified from this information. Thus, while creating tasks, more tasks can copy from the source that has a lower latency.

In another example scenario, policies can be enabled for disaster recovery. Considering that a disaster has occurred, storage systems can be loaded. Then, data can be pulled from two storage systems. This approach can distribute the read load across multiple systems, and decrease the time for the job to complete.

Prior approaches can generally lack an ability to select which data source to pull from. Rather, they generally describe one data source and one target, no matter how overloaded the source is at a time of restoration.

The present techniques can also apply to scenarios where cloud endpoints have rate limits for calls to a particular bucket, which can negatively impact data restoration time.

### Example Architecture, Etc.

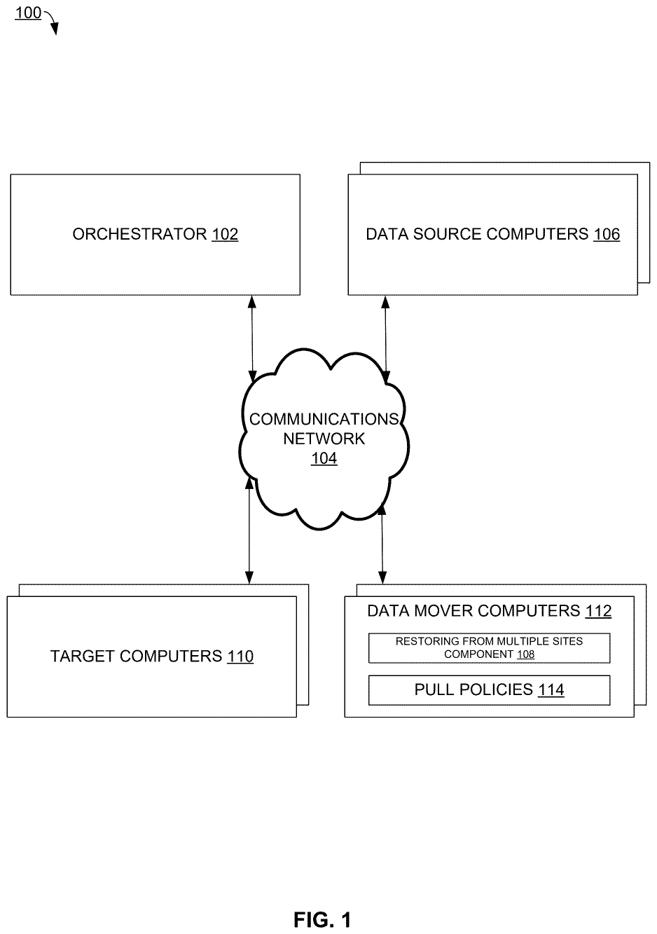

FIG. 1 illustrates an example system architecture 100 that can facilitate restoring from multiple sites, in accordance with an embodiment of this disclosure.

System architecture 100 comprises orchestrator 102, communications network 104, data source computers 106, target computers 110, and data mover computers 112. In turn, data mover computers 112 each comprise an instance of restoring from multiple sites component 108, and a pull policy of pull policies 114.

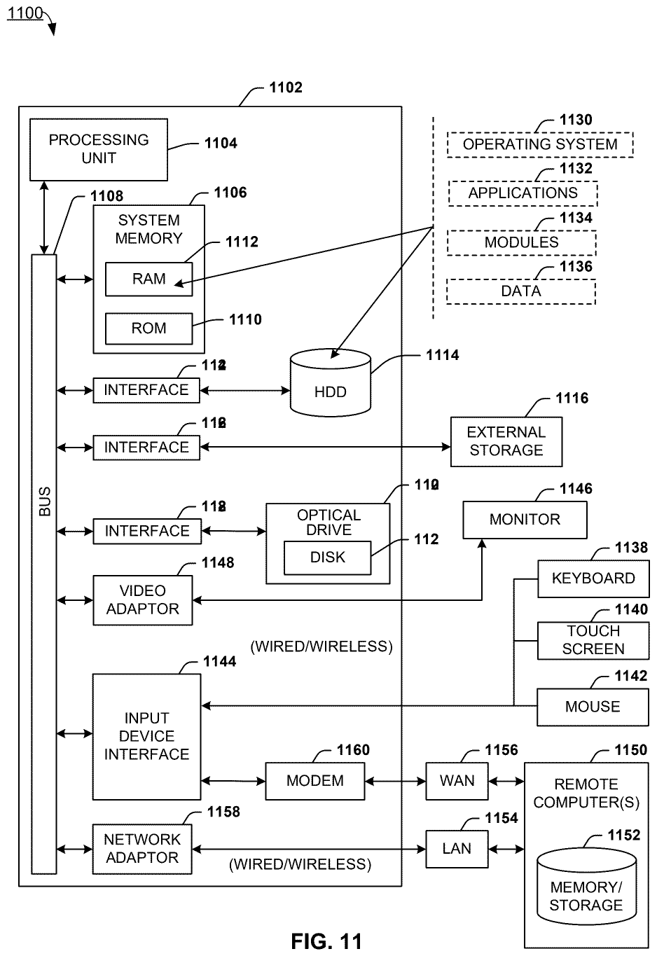

Each of orchestrator 102, data source computers 106, target computers 110, and/or data mover computers 112 can be implemented with part(s) of computing environment 1100 of FIG. 11. Communications network 104 can comprise a computer communications network, such as the Internet.

Orchestrator 102 can update pull policies 114 based on where which data sources indicated by pull policies 114 are stored by various computers of data source computers 106. When a data moving job is initiated on a data mover computer of data mover computers 112 (e.g., to copy data to a particular target computer of target computers 110), the corresponding instance of restoring from multiple sites component 108 can determine which data source(s) identified in the corresponding pull policy of pull policies 114 to use, and can effectuate the data move with the determined data source(s).

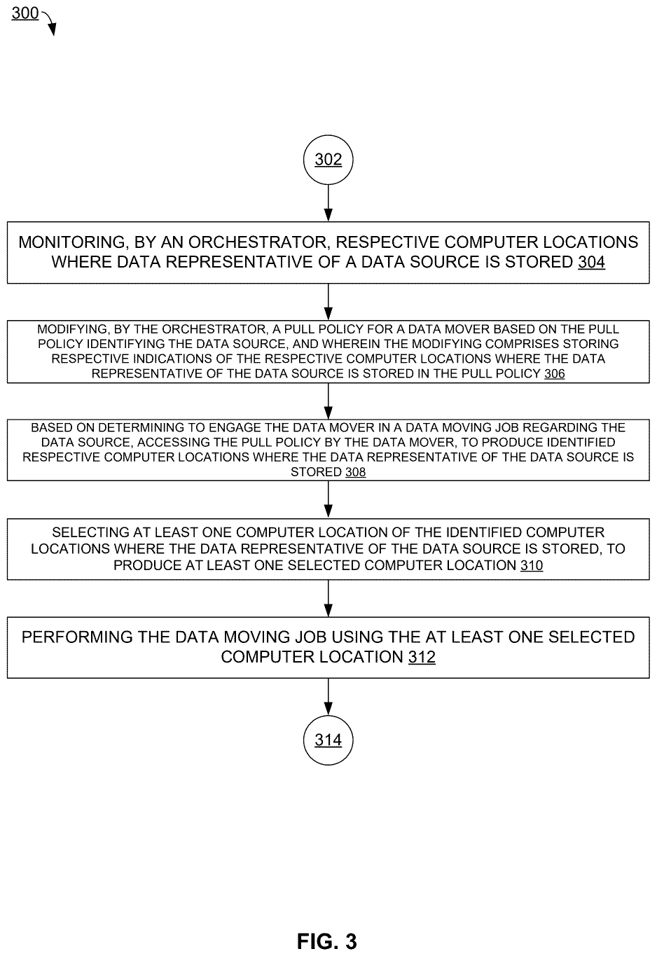

In some examples, restoring from multiple sites component 108 can implement part(s) of the process flows of FIGS. 3-10 to implement restoring from multiple sites.

It can be appreciated that system architecture 100 is one example system architecture for restoring from multiple sites, and that there can be other system architectures that facilitate restoring from multiple sites.

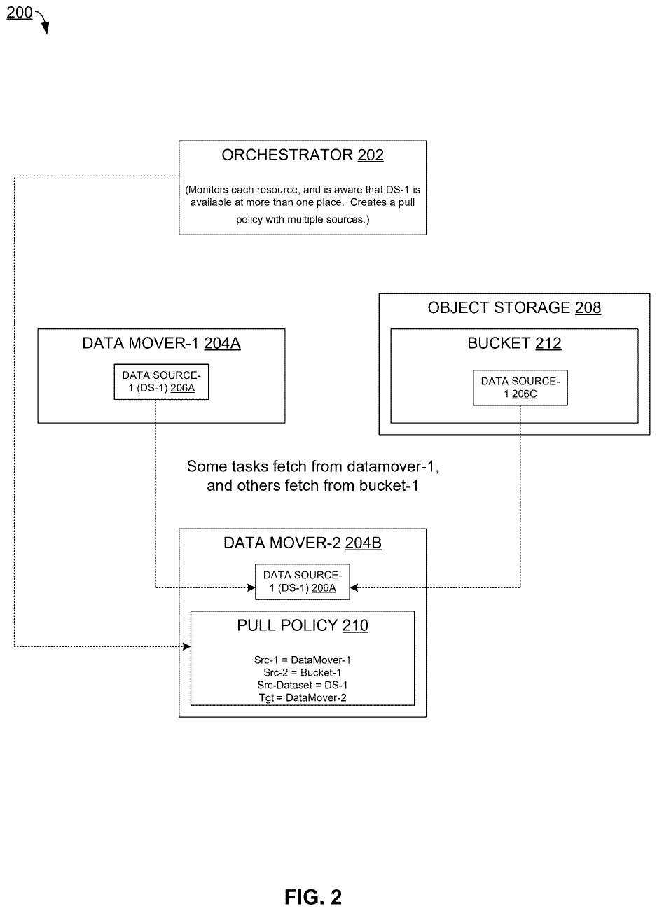

FIG. 2 illustrates another example system architecture 200 that can facilitate restoring from multiple sites, in accordance with an embodiment of this disclosure. In some examples, part(s) of system architecture 200 can be used by part(s) of system architecture 100 of FIG. 1 to facilitate restoring from multiple sites.

System architecture 200 comprises orchestrator 202, data mover-1 204A, data mover-2 204B, data source-1 (DS-1) 206A, data source-1 206B, data source-1 206C, object storage 208, pull policy 210, and bucket 212.

Orchestrator 202 can monitor resources, and so be aware that DS-1 is available in more than one location (here, DS-1 is available in both data mover-1 204A and bucket 212). Orchestrator 202 can create pull policy 210 with multiple sources.

To know where datasets are available, an orchestrator can be used. An identifier of a dataset (dataset-id) can be globally unique. Thus, the orchestrator can maintain a table of dataset-id versus storage system where the dataset resides (along with the path). Then, the orchestrator can identify whether a particular dataset resides in more than one place, and provide the details accordingly.

The present techniques can be implemented to run a job and tasks on one system, where some tasks are created to fetch from src-1, and other tasks are created to fetch from src-2.

### Example Process Flows

FIG. 3 illustrates another example process flow 300 that can facilitate restoring from multiple sites, in accordance with an embodiment of this disclosure. In some examples, one or more embodiments of process flow 300 can be implemented by restoring from multiple sites component 108 of FIG. 1, or computing environment 1100 of FIG. 11.

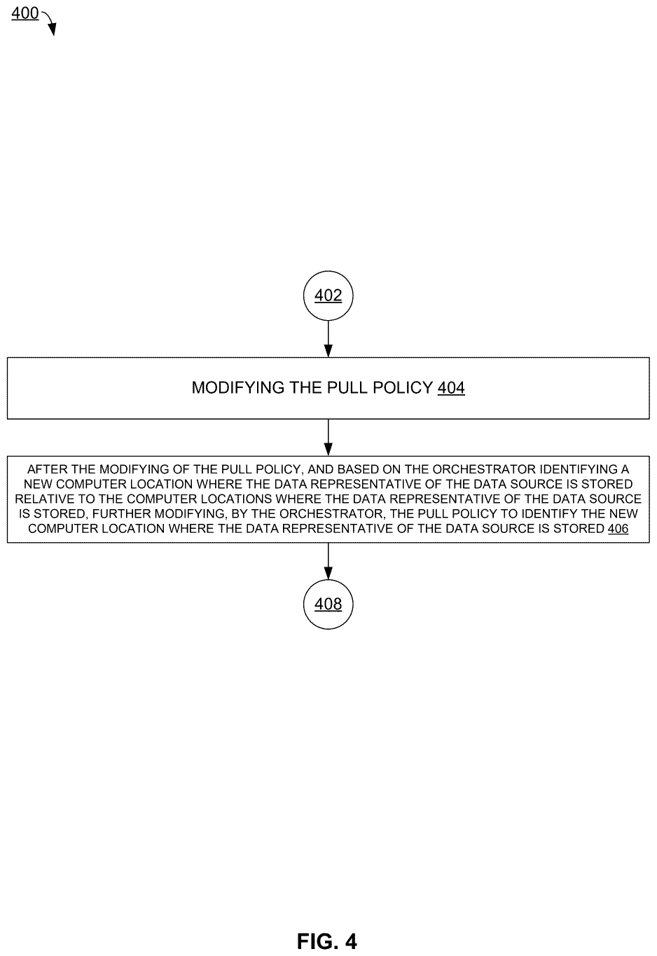

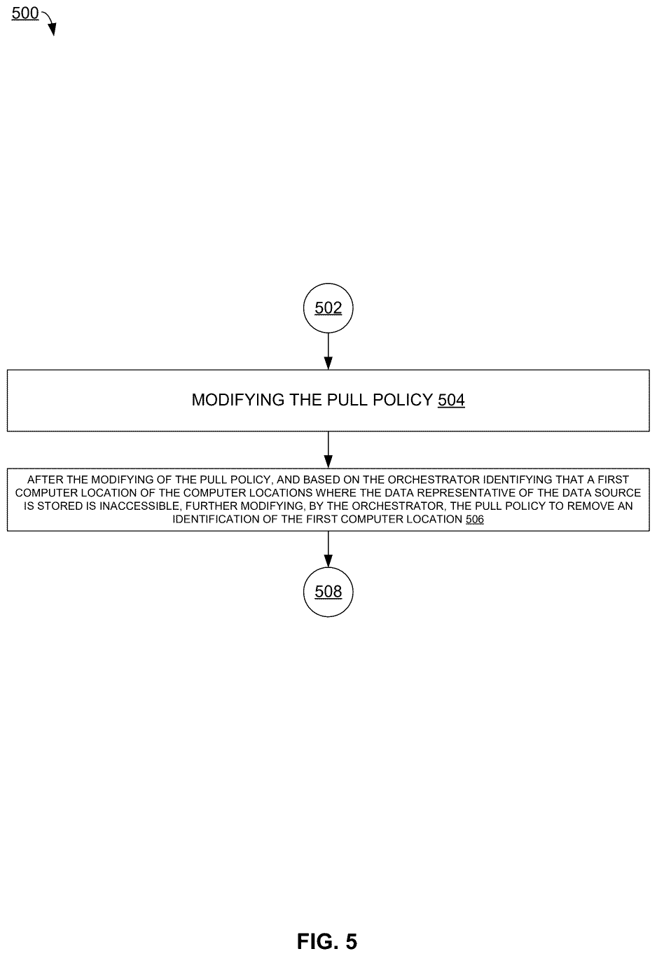

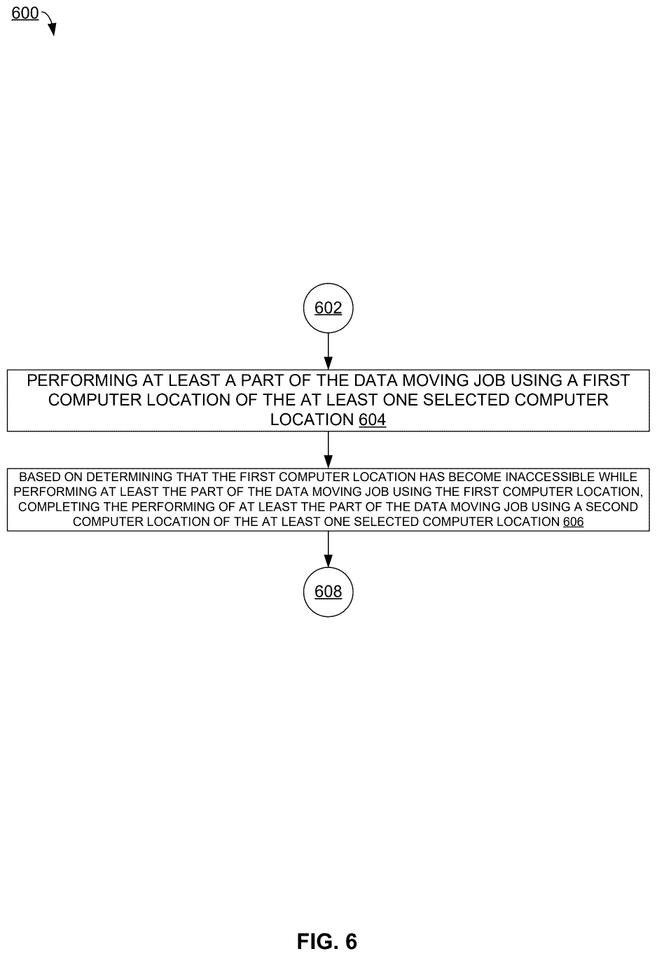

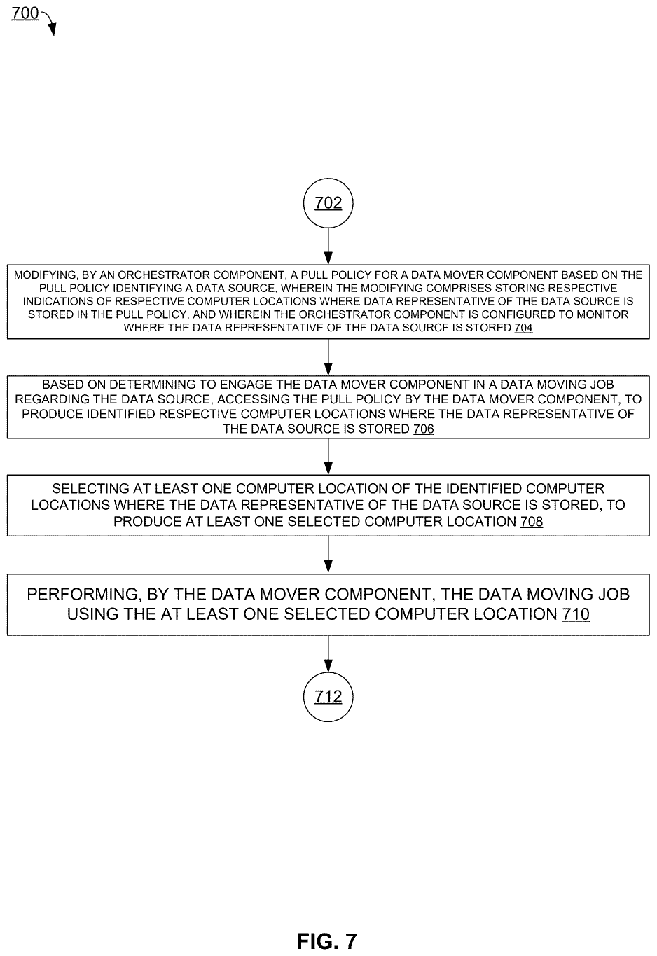

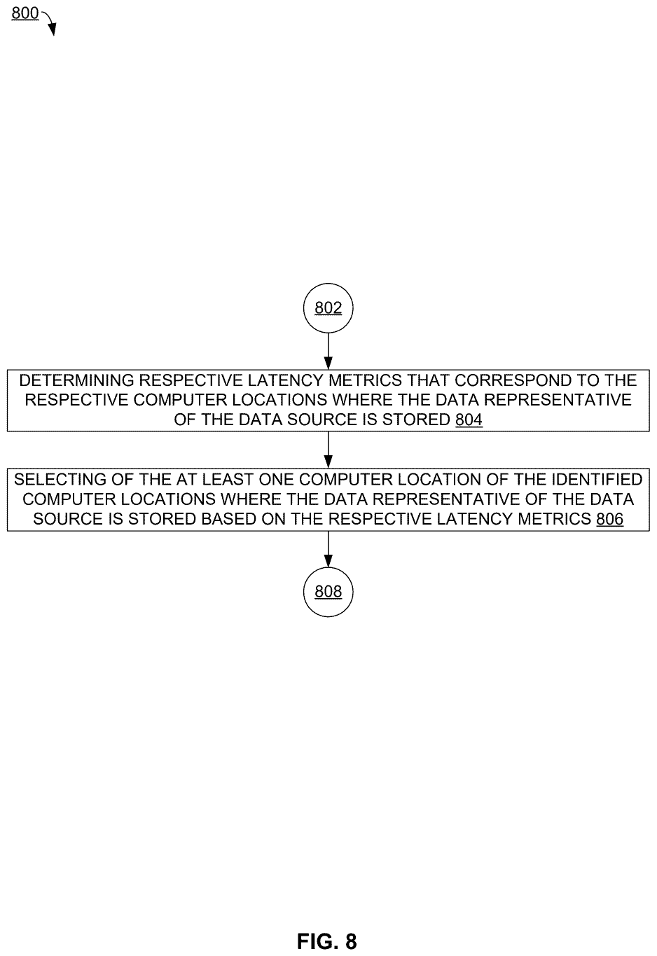

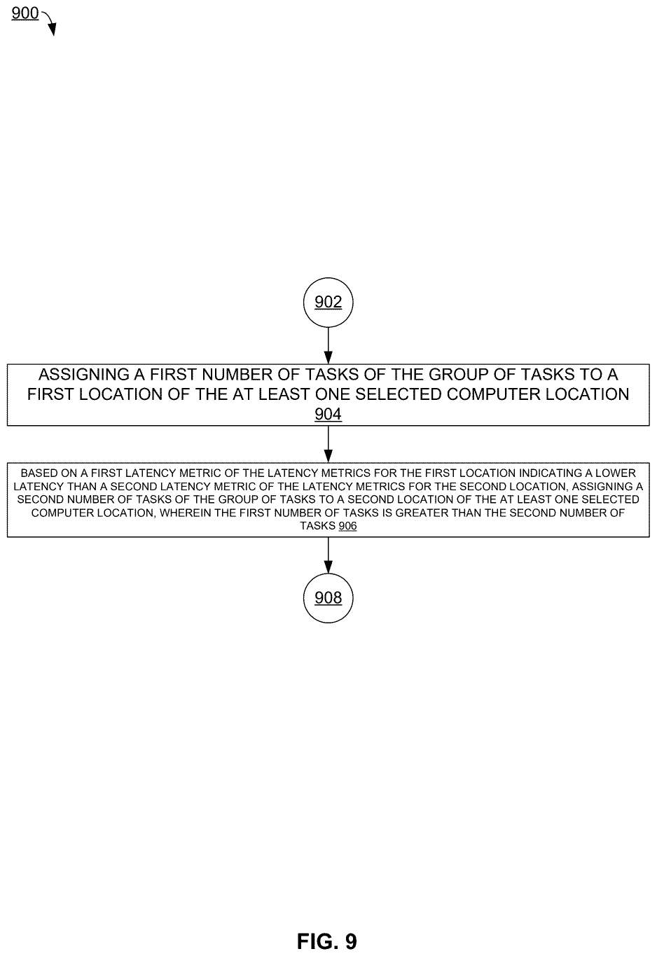

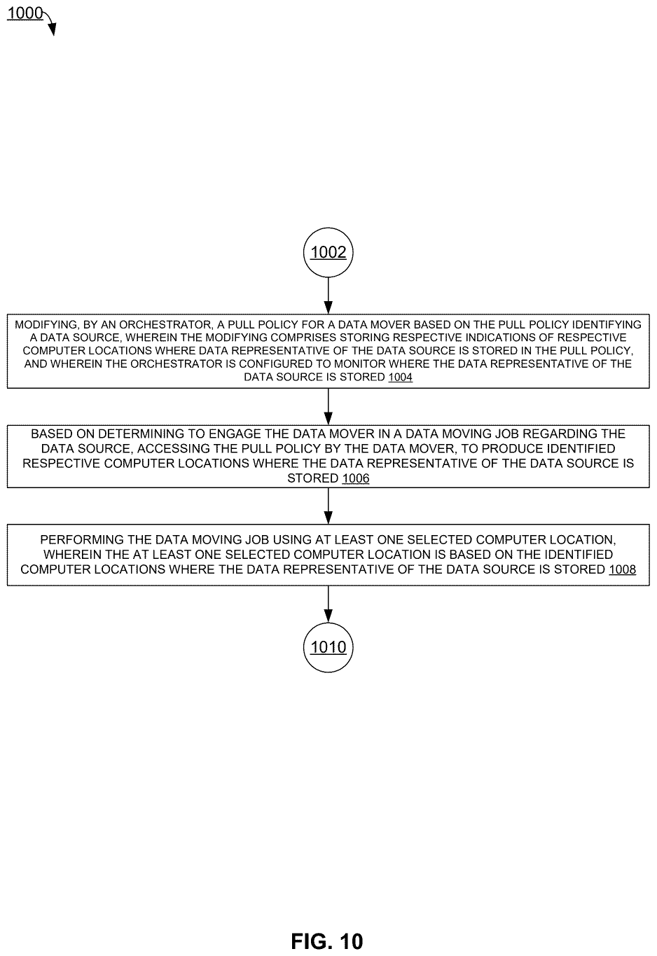

It can be appreciated that the operating procedures of process flow 300 are example operating procedures, and that there can be embodiments that implement more or fewer operating procedures than are depicted, or that implement the depicted operating procedures in a different order than as depicted. In some examples, process flow 300 can be implemented in conjunction with one or more embodiments of one or more of process flow 400 of FIG. 4, process flow 500 of FIG. 5, process flow 600 of FIG. 6, process flow 700 of FIG. 7, process flow 800 of FIG. 8, process flow 900 of FIG. 9, and/or process flow 1000 of FIG. 10.

Process flow 300 begins with 302, and moves to operation 304.

Operation 304 depicts monitoring, by an orchestrator, respective computer locations where data representative of a data source is stored. This orchestrator can be similar to orchestrator 202 of FIG. 2.

After operation 304, process flow 300 moves to operation 306.

Operation 306 depicts modifying, by the orchestrator, a pull policy for a data mover based on the pull policy identifying the data source, and wherein the modifying comprises storing respective indications of the respective computer locations where the data representative of the data source is stored in the pull policy. Continuing with the example of FIG. 2, this can comprise orchestrator 202 modifying pull policy 210.

In some examples, the orchestrator is configured to modify a group of pull policies that comprise the pull policy.

In some examples, the pull policy is a first pull policy, and the first pull policy differs from a second pull policy of the group of pull policies.

In some examples, respective pull policies of the group of pull policies correspond to respective data movers of a group of data movers that comprises the data mover.

That is, an orchestrator can manage multiple pull policies. These multiple pull policies can be different pull policies. Different data movers can use different pull policies.

After operation 306, process flow 300 moves to operation 308.

Operation 308 depicts, based on determining to engage the data mover in a data moving job regarding the data source, accessing the pull policy by the data mover, to produce identified respective computer locations where the data representative of the data source is stored. Continuing with the example of FIG. 2, the data mover can be similar to data mover-2 204B, which corresponds to pull policy 210, where pull policy 210 identifies DataMover-1 and Bucket-1 as sources.

After operation 308, process flow 300 moves to operation 310.

Operation 310 depicts selecting at least one computer location of the identified computer locations where the data representative of the data source is stored, to produce at least one selected computer location. That is, continuing with the example of FIG. 2, in various examples, one or more of DataMover-1 and Bucket-1 can be selected as the selected computer location.

After operation 310, process flow 300 moves to operation 312.

Operation 312 depicts performing the data moving job using the at least one selected computer location. That is, the location selected in 310 can be used as the data source for data moving.

In some examples, the data moving job comprises task agents, wherein a first task agent of the task agents accesses first data from a first location of the at least one selected computer location, and wherein a second task agent of the task agents accesses second data from a second location of the at least one selected computer location. That is, one job can comprise multiple tasks (which can generally comprise worker processes), and each task can access data at a different location.

After operation 312, process flow 300 moves to 314, where process flow 300 ends.

FIG. 4 illustrates another example process flow 400 that can facilitate restoring from multiple sites, in accordance with an embodiment of this disclosure. In some examples, one or more embodiments of process flow 400 can be implemented by restoring from multiple sites component 108 of FIG. 1, or computing environment 1100 of FIG. 11.

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of one or more of process flow 300 of FIG. 3, process flow 500 of FIG. 5, process flow 600 of FIG. 6, process flow 700 of FIG. 7, process flow 800 of FIG. 8, process flow 900 of FIG. 9, and/or process flow 1000 of FIG. 10.

Process flow 400 begins with 402, and moves to operation 404.

Operation 404 depicts modifying the pull policy. Using the example of FIG. 2, this can be pull policy 210, and operation 404 can be implemented in a similar manner as operation 306 of FIG. 3.

After operation 404, process flow 400 moves to operation 406.

Operation 406 depicts, after the modifying of the pull policy, and based on the orchestrator identifying a new computer location where the data representative of the data source is stored relative to the computer locations where the data representative of the data source is stored, further modifying, by the orchestrator, the pull policy to identify the new computer location where the data representative of the data source is stored. That is, an orchestrator can modify a pull policy to add a new/another data source.

After operation 406, process flow 400 moves to 408, where process flow 400 ends.

FIG. 5 illustrates another example process flow 500 that can facilitate restoring from multiple sites, in accordance with an embodiment of this disclosure. In some examples, one or more embodiments of process flow 500 can be implemented by restoring from multiple sites component 108 of FIG. 1, or computing environment 1100 of FIG. 11.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 300 of FIG. 3, process flow 400 of FIG. 4, process flow 600 of FIG. 6, process flow 700 of FIG. 7, process flow 800 of FIG. 8, process flow 900 of FIG. 9, and/or process flow 1000 of FIG. 10.

Process flow 500 begins with 502, and moves to operation 504.

Operation 504 depicts modifying the pull policy. Using the example of FIG. 2, this can be pull policy 210, and operation 504 can be implemented in a similar manner as operation 306 of FIG. 3.

After operation 504, process flow 500 moves to operation 506.

Operation 506 depicts, after the modifying of the pull policy, and based on the orchestrator identifying that a first computer location of the computer locations where the data representative of the data source is stored is inaccessible, further modifying, by the orchestrator, the pull policy to remove an identification of the first computer location. That is, an orchestrator can modify a pull policy to remove a data source, such as where the orchestrator determines that that data source is now inaccessible.

After operation 506, process flow 500 moves to 508, where process flow 500 ends.

FIG. 6 illustrates another example process flow 600 that can facilitate restoring from multiple sites, in accordance with an embodiment of this disclosure. In some examples, one or more embodiments of process flow 600 can be implemented by restoring from multiple sites component 108 of FIG. 1, or computing environment 1100 of FIG. 11.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 300 of FIG. 3, process flow 400 of FIG. 4, process flow 500 of FIG. 5, process flow 700 of FIG. 7, process flow 800 of FIG. 8, process flow 900 of FIG. 9, and/or process flow 1000 of FIG. 10.

Process flow 600 begins with 602, and moves to operation 604.

Operation 604 depicts performing at least a part of the data moving job using a first computer location of the at least one selected computer location. That is, a data mover job can be started and some data can be transferred.

After operation 604, process flow 600 moves to operation 606.

Operation 606 depicts, based on determining that the first computer location has become inaccessible while performing at least the part of the data moving job using the first computer location, completing the performing of at least the part of the data moving job using a second computer location of the at least one selected computer location. That is, when a data mover job is in progress, and the data source becomes inaccessible, there can be a failover to another data source (as specified in a pull policy).

In some examples, the determining that the first computer location has become inaccessible comprises determining that the first computer location is unresponsive via a communications network. That is, a data source can be determined to be inaccessible because it is not responsive to network communications.

After operation 606, process flow 600 moves to 608, where process flow 600 ends.

FIG. 7 illustrates another example process flow 700 that can facilitate restoring from multiple sites, in accordance with an embodiment of this disclosure. In some examples, one or more embodiments of process flow 700 can be implemented by restoring from multiple sites component 108 of FIG. 1, or computing environment 1100 of FIG. 11.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 300 of FIG. 3, process flow 400 of FIG. 4, process flow 500 of FIG. 5, process flow 600 of FIG. 6, process flow 800 of FIG. 8, process flow 900 of FIG. 9, and/or process flow 1000 of FIG. 10.

Process flow 700 begins with 702, and moves to operation 704.

Operation 704 depicts modifying, by an orchestrator component, a pull policy for a data mover component based on the pull policy identifying a data source, wherein the modifying comprises storing respective indications of respective computer locations where data representative of the data source is stored in the pull policy, and wherein the orchestrator component is configured to monitor where the data representative of the data source is stored. In some examples, operation 704 can be implemented in a similar manner as operation 306 of FIG. 3.

After operation 704, process flow 700 moves to operation 706.

Operation 706 depicts, based on determining to engage the data mover component in a data moving job regarding the data source, accessing the pull policy by the data mover component, to produce identified respective computer locations where the data representative of the data source is stored. In some examples, operation 706 can be implemented in a similar manner as operation 308 of FIG. 3.

After operation 706, process flow 700 moves to operation 708.

Operation 708 depicts selecting at least one computer location of the identified computer locations where the data representative of the data source is stored, to produce at least one selected computer location. In some examples, operation 708 can be implemented in a similar manner as operation 310 of FIG. 3.

In some examples, the selecting of at least one computer location of the identified computer locations where the data representative of the data source is stored comprises selecting all computer locations of the identified computer locations where the data representative of the data source is stored, based on a disaster criterion being satisfied. That is, in a disaster scenario, data can be pulled from multiple storage systems, to distribute the read load, and increase a chance that the job will complete before the disaster prevents unfinished jobs from completing.

After operation 708, process flow 700 moves to operation 710.

Operation 710 depicts performing, by the data mover component, the data moving job using the at least one selected computer location. In some examples, operation 710 can be implemented in a similar manner as operation 312 of FIG. 3.

In some examples, the data moving job comprises tasks, a first task of the tasks a first location of the at least one selected computer location, and wherein a task of the task accesses a second location of the at least one selected computer location.

After operation 710, process flow 700 moves to 712, where process flow 700 ends.

FIG. 8 illustrates another example process flow 800 that can facilitate restoring from multiple sites, in accordance with an embodiment of this disclosure. In some examples, one or more embodiments of process flow 800 can be implemented by restoring from multiple sites component 108 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 300 of FIG. 3, process flow 400 of FIG. 4, process flow 500 of FIG. 5, process flow 600 of FIG. 6, process flow 700 of FIG. 7, process flow 900 of FIG. 9, and/or process flow 1000 of FIG. 10.

Process flow 800 begins with 802, and moves to operation 804.

Operation 804 depicts determining respective latency metrics that correspond to the respective computer locations where the data representative of the data source is stored. This latency can relate to data transfer speeds.

After operation 804, process flow 800 moves to operation 806.

Operation 806 depicts selecting of the at least one computer location of the identified computer locations where the data representative of the data source is stored based on the respective latency metrics. That is, which data source(s) to use for a data mover job can be determined based on those data sources'respective latencies.

After operation 806, process flow 800 moves to operation 808, where process flow 800 ends.

FIG. 9 illustrates another example process flow 900 that can facilitate restoring from multiple sites, in accordance with an embodiment of this disclosure. In some examples, one or more embodiments of process flow 900 can be implemented by restoring from multiple sites component 108 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 300 of FIG. 3, process flow 400 of FIG. 4, process flow 500 of FIG. 5, process flow 600 of FIG. 6, process flow 700 of FIG. 7, process flow 800 of FIG. 8, and/or process flow 1000 of FIG. 10.

Process flow 900 begins with 902, and moves to operation 904.

In process flow 900, the data moving job comprises a group of tasks.

Operation 904 depicts assigning a first number of tasks of the group of tasks to a first location of the at least one selected computer location. That is, a data mover job can comprise multiple tasks, which can generally comprise worker processes that are responsible for moving data. One or more of these tasks can be assigned to use a first data source.

After operation 904, process flow 900 moves to operation 906.

Operation 906 depicts, based on a first latency metric of the latency metrics for the first location indicating a lower latency than a second latency metric of the latency metrics for the second location, assigning a second number of tasks of the group of tasks to a second location of the at least one selected computer location, wherein the first number of tasks is greater than the second number of tasks. That is, more tasks can be assigned to a particular data source when it has lower latency than another data source (which can still be assigned to tasks, albeit a smaller number of tasks).

After operation 906, process flow 900 moves to 908, where process flow 900 ends.

FIG. 10 illustrates another example process flow 1000 that can facilitate restoring from multiple sites, in accordance with an embodiment of this disclosure. In some examples, one or more embodiments of process flow 1000 can be implemented by restoring from multiple sites component 108 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 300 of FIG. 3, process flow 400 of FIG. 4, process flow 500 of FIG. 5, process flow 600 of FIG. 6, process flow 700 of FIG. 7, process flow 800 of FIG. 8, and/or process flow 900 of FIG. 9.

Process flow 1000 begins with 1002, and moves to operation 1004.

Operation 1004 depicts modifying, by an orchestrator, a pull policy for a data mover based on the pull policy identifying a data source, wherein the modifying comprises storing respective indications of respective computer locations where data representative of the data source is stored in the pull policy, and wherein the orchestrator is configured to monitor where the data representative of the data source is stored. In some examples, operation 1004 can be implemented in a similar manner as operation 306 of FIG. 3.

In some examples, an identifier for the data representative of the data source is globally unique within the system among data source identifiers.

In some examples, the orchestrator maintains an association between the identifier for the data source and the computer locations where the data representative of the data source is stored.

In some examples, the respective computer locations where the data representative of the data source is stored comprise respective paths that identify where the data representative of the data source is stored at the respective computer locations.

That is, a dataset-id can be globally unique. Thus, the orchestrator can maintain a table of dataset-id and corresponding storage system(s) where the dataset resides (along with the path on those storage systems).

After operation 1004, process flow 1000 moves to operation 1006.

Operation 1006 depicts, based on determining to engage the data mover in a data moving job regarding the data source, accessing the pull policy by the data mover, to produce identified respective computer locations where the data representative of the data source is stored. In some examples, operation 1006 can be implemented in a similar manner as operation 308 of FIG. 3.

After operation 1006, process flow 1000 moves to operation 1008.

Operation 1008 depicts performing the data moving job using at least one selected computer location, wherein the at least one selected computer location is based on the identified computer locations where the data representative of the data source is stored. In some examples, operation 1008 can be implemented in a similar manner as operations 310-312 of FIG. 3.

In some examples, the at least one selected computer location is based on respective latency metrics of the respective computer locations where the data representative of the data source is stored.

In some examples, the at least one selected computer location is selected based on assigning a first number of tasks of the data moving job to a first location of the at least one selected computer location, and based on a first latency metric of the latency metrics for the first location indicating a lower latency than a second latency metric of the latency metrics for the second location, assigning a second number of tasks of the data moving job to a second location of the at least one selected computer location, wherein the first number of tasks is greater than the second number of tasks.

After operation 1008, process flow 1000 moves to 1010, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of orchestrator 102, data source computers 106, target computers 110, and/or data mover computers 112

In some examples, computing environment 1100 can implement one or more embodiments of the process flows of FIGS. 3-10 to facilitate restoring from multiple sites.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the . NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can also be connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
monitoring, by an orchestrator of the system, respective computer locations where data representative of a data source is stored;
modifying, by the orchestrator, a pull policy for a data mover based on the pull policy identifying the data source, and wherein the modifying comprises storing respective indications of the respective computer locations where the data representative of the data source is stored in the pull policy;
based on determining to engage the data mover in a data moving job regarding the data source, accessing the pull policy by the data mover, to produce identified respective computer locations where the data representative of the data source is stored;
selecting at least one computer location of the identified computer locations where the data representative of the data source is stored, to produce at least one selected computer location; and
performing the data moving job using the at least one selected computer location.

2. The system of claim 1, wherein the data moving job comprises task agents, wherein a first task agent of the task agents accesses first data from a first location of the at least one selected computer location, and wherein a second task agent of the task agents accesses second data from a second location of the at least one selected computer location.

3. The system of claim 1, wherein the operations further comprise:
after the modifying of the pull policy, and based on the orchestrator identifying a new computer location where the data representative of the data source is stored relative to the computer locations where the data representative of the data source is stored, further modifying, by the orchestrator, the pull policy to identify the new computer location where the data representative of the data source is stored.

4. The system of claim 1, wherein the operations further comprise:
after the modifying of the pull policy, and based on the orchestrator identifying that a first computer location of the computer locations where the data representative of the data source is stored is inaccessible, further modifying, by the orchestrator, the pull policy to remove an identification of the first computer location.

5. The system of claim 1, wherein the orchestrator is configured to modify a group of pull policies that comprise the pull policy.

6. The system of claim 5, wherein the pull policy is a first pull policy, and wherein the first pull policy differs from a second pull policy of the group of pull policies.

7. The system of claim 5, wherein respective pull policies of the group of pull policies correspond to respective data movers of a group of data movers that comprises the data mover.

8. The system of claim 1, wherein the performing of the data moving job using the at least one selected computer location comprises:
performing at least a part of the data moving job using a first computer location of the at least one selected computer location; and
based on determining that the first computer location has become inaccessible while performing at least the part of the data moving job using the first computer location, completing the performing of at least the part of the data moving job using a second computer location of the at least one selected computer location.

9. The system of claim 8, wherein the determining that the first computer location has become inaccessible comprises determining that the first computer location is unresponsive via a communications network.

10. A method, comprising:
modifying, by an orchestrator component of a system comprising at least one processor, a pull policy for a data mover component based on the pull policy identifying a data source, wherein the modifying comprises storing respective indications of respective computer locations where data representative of the data source is stored in the pull policy, and wherein the orchestrator component is configured to monitor where the data representative of the data source is stored;
based on determining to engage the data mover component in a data moving job regarding the data source, accessing the pull policy by the data mover component, to produce identified respective computer locations where the data representative of the data source is stored;
selecting, by the system, at least one computer location of the identified computer locations where the data representative of the data source is stored, to produce at least one selected computer location; and
performing, by the data mover component, the data moving job using the at least one selected computer location.

11. The method of claim 10, further comprising:
determining, by the system, respective latency metrics that correspond to the respective computer locations where the data representative of the data source is stored,
wherein the selecting of the at least one computer location of the identified computer locations where the data representative of the data source is stored is performed based on the respective latency metrics.

12. The method of claim 11, wherein the data moving job comprises a group of tasks, and wherein the selecting of the at least one computer location of the identified computer locations where the data representative of the data source is stored comprises:
assigning a first number of tasks of the group of tasks to a first location of the at least one selected computer location; and
based on a first latency metric of the latency metrics for the first location indicating a lower latency than a second latency metric of the latency metrics for the second location, assigning a second number of tasks of the group of tasks to a second location of the at least one selected computer location, wherein the first number of tasks is greater than the second number of tasks.

13. The method of claim 10, wherein the selecting of at least one computer location of the identified computer locations where the data representative of the data source is stored comprises selecting all computer locations of the identified computer locations where the data representative of the data source is stored, based on a disaster criterion being satisfied.

14. The method of claim 10, wherein the data moving job comprises tasks, wherein a first task of the tasks a first location of the at least one selected computer location, and wherein a second task of the task accesses a second location of the at least one selected computer location.

15. A non-transitory computer-readable medium comprising instructions that, in response to execution, cause a system comprising at least one processor to perform operations, comprising:
modifying, by an orchestrator, a pull policy for a data mover based on the pull policy identifying a data source, wherein the modifying comprises storing respective indications of respective computer locations where data representative of the data source is stored in the pull policy, and wherein the orchestrator is configured to monitor where the data representative of the data source is stored;
based on determining to engage the data mover in a data moving job regarding the data source, accessing the pull policy by the data mover, to produce identified respective computer locations where the data representative of the data source is stored; and
performing the data moving job using at least one selected computer location, wherein the at least one selected computer location is based on the identified computer locations where the data representative of the data source is stored.

16. The non-transitory computer-readable medium of claim 15, wherein an identifier for the data representative of the data source is globally unique within the system among data source identifiers.

17. The non-transitory computer-readable medium of claim 16, wherein the orchestrator maintains an association between the identifier for the data source and the computer locations where the data representative of the data source is stored.

18. The non-transitory computer-readable medium of claim 15, wherein the respective computer locations where the data representative of the data source is stored comprise respective paths that identify where the data representative of the data source is stored at the respective computer locations.

19. The non-transitory computer-readable medium of claim 15, wherein the at least one selected computer location is based on respective latency metrics of the respective computer locations where the data representative of the data source is stored.

20. The non-transitory computer-readable medium of claim 19, wherein the at least one selected computer location is selected based on operations comprising:
assigning a first number of tasks of the data moving job to a first location of the at least one selected computer location; and
based on a first latency metric of the latency metrics for the first location indicating a lower latency than a second latency metric of the latency metrics for the second location, assigning a second number of tasks of the data moving job to a second location of the at least one selected computer location, wherein the first number of tasks is greater than the second number of tasks.
